(19) United States
(12) Patent Application Publication
(10) Pub. No.: US 2006/0076888 A1
(43) Pub. Date: Apr. 13, 2006

(54) Plasma display panel

(76) Inventor: Seok-Gyun Woo, Suwon-si (KR)

Correspondence Address: CHRISTIE, PARKER & HALE, LLP, PO BOX 7068, PASADENA, CA, 91109-7068, US

(21) Appl. No.: 11/181,058

(22) Filed: Jul. 13, 2005

(30) Foreign Application Priority Data
Oct. 11, 2004 (KR) 10-2004-0080868

(51) Int. Cl. H01J 17/49

(52) U.S. Cl. 313/582

(57) ABSTRACT

A plasma display panel having a display region that includes discharge cells defined by barrier ribs and a non-display region formed outside the display region. The non-display region includes dummy barrier ribs. The ends of the dummy barrier ribs adjacent the sealing line and the sealing line itself define a gap with a size that is greater than a maximum error range for forming the sealing line and may be equal to or smaller than 140% of the maximum error range. The use of dummy barrier ribs can effectively eliminate a noise source otherwise formed outside the display region.

### CROSS-REFERENCE TO RELATED APPLICATION

This application claims priority to and the benefit of Korean Patent Application No. 10-2004-0080868 filed in the Korean Intellectual Property Office on Oct. 11, 2004, the entire content of which is incorporated herein by reference.

### BACKGROUND OF THE INVENTION

(a) Field of the Invention

The present invention relates to a plasma display panel, and more particularly, to a plasma display panel that is capable of eliminating a noise source that is generated outside of a display region.

(b) Description of the Related Art

Generally, a plasma display panel (hereinafter, referred to as ‘PDP’) has a structure with a rear panel and a front panel that are bonded to each other to encase a discharge gas. The front panel includes a front substrate, a display electrode formed on the back surface of the front substrate, a dielectric layer and a protective film to cover the display electrodes. The rear panel includes a rear substrate, address electrodes formed over the entire surface of the rear substrate so as to cross the display electrodes, a dielectric layer to cover the address electrodes, barrier ribs formed on the dielectric layer for defining discharge cells and phosphor layers formed in each of the discharge cells.

After an address discharge, a PDP constructed in this way is driven by executing a sustaining discharge and reset discharge. That is, when sustaining pulses are applied to the display electrodes, an electric field is generated between the respective address electrodes and display electrodes in each discharge cell. As a result, the discharge gas is excited to a plasma state having a high energy level and then is stabilized to a state having a low energy level. Ultraviolet rays are generated, which causes the phosphor to be in a state in which an energy level is high. The phosphor radiates visible rays and is then stabilized to a state having a low energy level, thereby achieving a desired image.

The PDP includes a display region in which an image is displayed. This region includes a set of barrier ribs between the front substrate and the rear substrate. The PDP also includes a dummy region formed above and below the display region such that even though the barrier ribs are present in this region, substantial discharge is not generated. The PDP further includes a margin region that is formed without barrier ribs on the left and right sides of the display region and above and below the dummy region.

A PDP having the above-mentioned structure therefore includes a front substrate and a rear substrate that adhere closely to each other through the barrier ribs in the display region and the dummy region. Because terminal portions of the display electrodes and terminal connecting portions are placed on the front substrate in the margin region, but the barrier ribs are not placed on the rear substrate in this margin region, an empty space is formed between the front substrate and the rear substrate in the margin region. This empty space is generally formed outside the display region of the PDP.

A natural frequency of the PDP and a driving frequency of the PDP applied to the display electrodes by a driving circuit are within a range of resonance frequencies. Noise occurs due to this resonance and the noise is amplified in the space formed between the front substrate and the rear substrate in the margin region.

### SUMMARY OF THE INVENTION

Embodiments of the invention provide a plasma display panel capable of effectively removing a noise source that is formed outside of the display region. In one embodiment off the present invention, a plasma display panel includes: a pair of substrates that are bonded along a sealing line that is formed adjacent to an edge of a region where the substrates overlap while opposing each other; a display region that includes discharge cells divided by barrier ribs formed within the overlapping region between the pair of substrates, phosphor layers formed in the respective discharge cells and electrodes provided to correspond to each discharge cell so as to enable the display of an image; and a non-display region formed outside the display region. The non-display region includes a dummy region having dummy barrier ribs and a margin region formed between the dummy region and the sealing line. In one embodiment, the margin region may be smaller than the dummy region.

In one embodiment, the margin region has a width C that is greater than a maximum error range in forming the sealing line and is equal to or smaller than 140% of the maximum error range. The margin region may have a width C of 1.5 mm<C≦2 mm. In one embodiment, the dummy barrier ribs have the same pattern as the barrier ribs. In one embodiment, the sealing line is formed of glass frit.

In another embodiment, a plasma display panel includes: a pair of substrates that are bonded along the sealing line that is formed adjacent to an edge of a region where the substrates overlap while opposing each other; a display region that includes discharge cells divided by barrier ribs that are formed within the overlapping region between the pair of substrates, phosphor layers formed in the respective-discharge cells, and electrodes that correspond to the respective discharge cells so as to enable the display of an image; and a non-display region formed outside the display region. The non-display region includes dummy barrier ribs each having one end connected to the display region. The other ends of the dummy barrier ribs together with the sealing line define a gap. The gap is greater than a maximum error range in forming the sealing line and is equal to or smaller than 140% of the maximum error range.

The non-display region includes a dummy region that is formed outside the display region and has dummy barrier ribs. The dummy barrier ribs have the same pattern as the barrier ribs to simplify the manufacturing process.

The non-display region has a margin region having a width corresponding to the gap formed between the dummy barrier rib and the sealing line. The margin region has a width C of 1.5 mm<C≦2 mm. This structure prevents an edge effect from being generated that is due to non-uniform discharge of the discharge cells located at the outermost section of the display region. By minimizing and removing the empty space formed between the substrates in the non-display region, it is possible to effectively eliminate the noise source generated outside the display region.

### BRIEF DESCRIPTION OF THE DRAWINGS

FIG. 1 is a perspective view showing a plasma display panel according to an embodiment of the present invention.

FIG. 2 is an exploded perspective view partially showing the plasma display panel according to an embodiment the present invention.

FIG. 3 is a sectional view along the line III-III of FIG. 1.

FIG. 4 is a perspective view showing a rear panel.

FIG. 5 is a plan view partially showing the rear panel.

### DETAILED DESCRIPTION

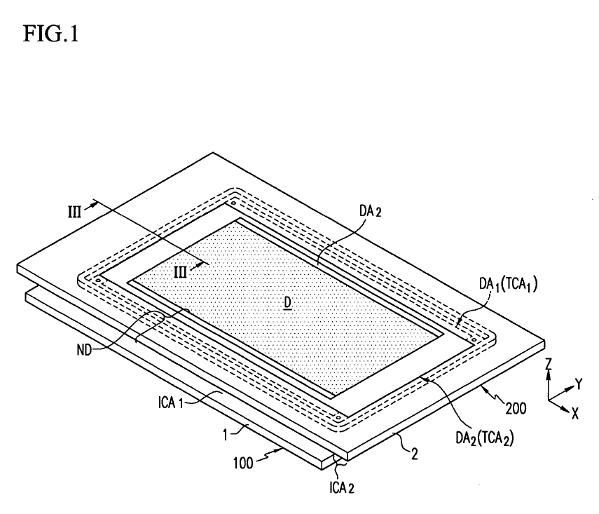

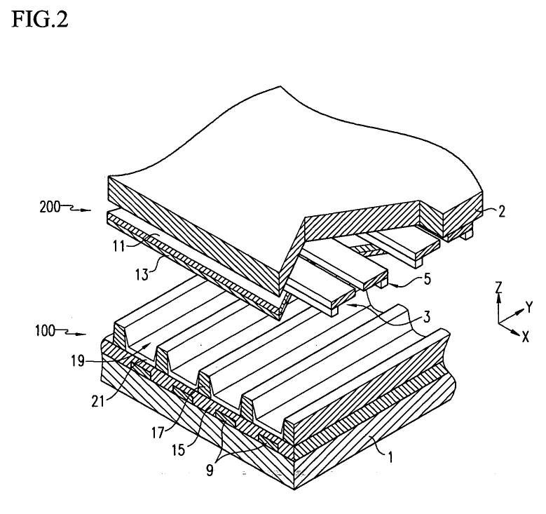

Referring to FIG. 1 and FIG. 2, the PDP, according to one embodiment, is formed by bonding a first panel 100 (hereinafter, referred to as ‘a rear panel’) and a second panel 200 (hereinafter, referred to as ‘a front panel’) to one another to enable the generation of an image using internal gas discharge. In the PDP, the size of a space for generating the gas discharge is much smaller than the thicknesses of the rear panel 100 and the front panel 200. FIG. 1 shows a PDP in which both substrates, that is, a rear substrate 1 and a front substrate 2 are directly bonded to each other.

Referring now to FIG. 2, the PDP according to one embodiment includes sustaining electrodes 3 and scanning electrodes 5, functioning as display electrodes, formed on an inner surface of the front substrate 2 of the front panel 200, and address electrodes 9 formed on an inner surface of the rear substrate 1 of the rear panel 100. The sustaining electrodes 3 and the scanning electrodes 5 are formed on the inner surface of the front substrate 2 and are covered by a deposition of a dielectric layer 11 and a protective film 13. In addition, the address electrodes 9 are formed on the inner surface of the rear substrate 1 and are covered with a dielectric layer 15. Partition walls or barrier ribs 17 are formed on the dielectric layer 15 to form discharge cells 19. A phosphor layer 21 is provided in each discharge cell 19. The discharge cell 19 is charged with an inert gas, such as a mixture of Ne and Xe. The display electrodes 3 and 5 and the address electrode 9 cross each other with the discharge cell 19 interposed therebetween, so that the discharge cell 19 can be selected. In one embodiment, the barrier ribs 17 are formed as a set of strips which extend only in one direction (Y-axis direction), but may be formed in a matrix with a set of crossing strips that extend in an X-axis direction and a Y-axis direction.

When a PDP having the above-mentioned structure is driven, an address discharge is generated by scanning pulses that are applied to the scanning electrode 5 and address pulses that are applied to the address electrode 9 for an address interval, so that a discharge cell 19 to be turned on is selected. A sustaining discharge is generated by sustaining pulses being alternately applied to the scanning electrode 5 and the sustaining electrode 3, so that the selected discharge cells 19 generate an image.

Referring again to FIG. 1, the PDP has a display region D that directly displays images through the address discharge, the sustaining discharge and the reset charge. A non-display region ND is formed outside of the display region D and does not display images. The non-display region ND is the entire remaining region outside of the display region D in the PDP.

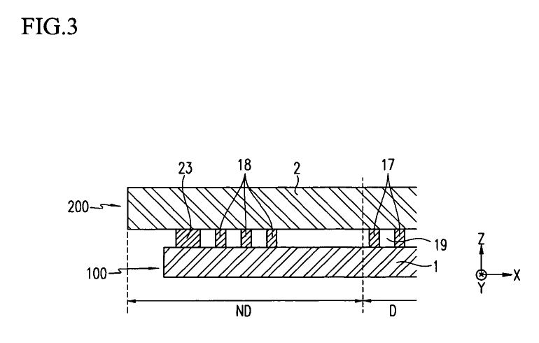

Referring now to FIG. 3, the rear panel 100 and the front panel 200 are airtightly bonded along a sealing line 23. The substrates 1 and 2 of both panels 100 and 200 are bonded along the sealing line 23, which is adjacent to an edge of a region where the substrates 1 and 2 overlap while opposing each other. The sealing line 23 may be formed of glass frit having the same properties as the rear substrate 1 and the front substrate 2, which are formed of glass. By using this structure, when heat is applied, such as in a plastic process, it is possible to sustain the sealing structure between the rear panel 100 and the front panel 200.

Within the overlapping region between the two substrates 1 and 2, a display region D is provided with barrier ribs 17. The discharge cells 19 are each defined by the barrier ribs 17. Phosphor layers 21 are formed in each of the discharge cells 19. The electrodes 3, 5 and 9 are provided so as to correspond to the discharge cells 19, thereby enabling the display of an image. The non-display region ND is formed outside the display region D. The non-display region ND includes an overlapping region between the substrates 1 and 2 that excludes the display region D and interconnection regions ICA₁ and ICA₂ (See FIG. 1) formed outside the overlapping region.

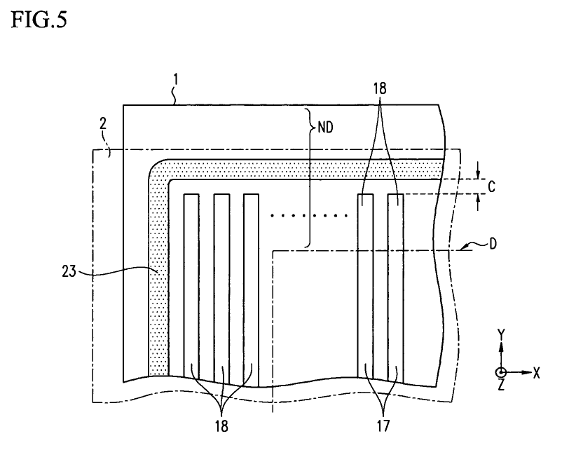

The PDP generates vibration and noise caused by resonance at a natural frequency of the PDP and at a driving frequency that is applied to the display electrode by the driving circuit. Because the generated vibration and noise are amplified between the rear panel 100 and the front panel 200 in the non-display region ND formed outside the display region D, dummy barrier ribs 18 are provided between the rear substrate 1 and the front substrate 2 in the non-display region ND. The non-display region ND includes a dummy region (DA: DA₁ and DA₂ in FIG. 1) having the dummy barrier ribs 18 within the overlapping region of the substrates 1 and 2, and a margin region C (See FIG. 5) formed between the dummy region (DA: DA₁ and DA₂) and the sealing line 23. Minimizing the area of the margin region C to make the dummy region (DA: DA₁ and DA₂) larger than the margin region C effectively eliminates the noise source.

In one embodiment, the margin region C is formed in a space defined by a minimum gap size C and is formed to have a minimum size. Because the gap size C depends on an error range in forming the sealing line 23, the gap size C may be greater than a maximum error range in forming the sealing line 23 and may be equal to or smaller than 140% of the maximum error range. Since a typical error size in forming the sealing line 23 is 1.5 mm, the interval C may be about 2 mm, which is greater than 1.5 mm. That is, the margin region C can be formed with a gap size C where 1.5 mm<gap size C≦2 mm.

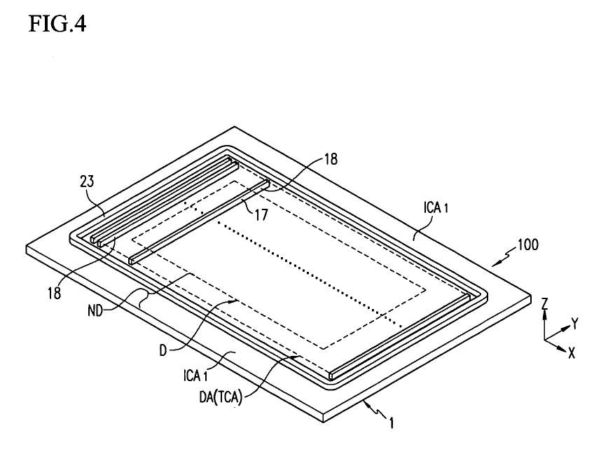

As shown in FIGS. 3 and 4, the dummy barrier ribs 18 are formed with the same pattern as the barrier ribs 17 formed in the display region D. The dummy barrier ribs 18 formed in the dummy region (DA: DA₁ and DA₂) of the non-display region ND may be separately formed with different patterns from those of the barrier ribs 17 in the display region D. However, the dummy barrier ribs may be formed with the same pattern as the barrier ribs 17 in the display region D to extend from the barrier ribs 17 to simplify the manufacturing process. The dummy barrier ribs 18 formed in the dummy region (DA: DA₁ and DA₂) of the non-display region ND are formed outside the display region D within the overlapping region of the rear panel 100 and the front panel 200, which minimizes the empty space formed between the rear panel 100 and the front panel 200. The dummy barrier ribs 18 fill in the space between the rear panel 100 and the front panel 200 in the non-display region ND, thereby removing the noise space in the PDP, that is, in the non-display region ND. The rear substrate 1 and the front substrate 2 keep a contacting state in the non-display region ND. Therefore, when the PDP is driven, the vibration and noise caused by the resonance amplification in the non-display region ND can be minimized.

The dummy barrier ribs 18 formed in the dummy region (DA: DA₁ and DA₂) of the non-display region ND should form a structure to fill in a space outside the display region D between the rear substrate 1 and the front substrate 2 and at the same time, keep a passage between the rear panel 100 and the front panel 200 open for evacuation of discharge cells and for the supply of discharge gases.

Therefore, as shown in FIG. 5, the dummy barrier ribs 18 in the non-display region ND are formed by extending the barrier ribs 17 of the display region D up to the sealing line 23 and maintaining the passage between the rear panel and the front panel 200. Removing the noise source outside the display region D is most effective when the ends of the dummy barrier ribs 18 in the non-display region ND approach the sealing line 23 within the maximum sealing error range in which the front ends would not come in contact with the sealing line 23.

The non-display region ND includes the dummy region DA₁ formed outside the display region D for example on the rear substrate 1. An interconnection region ICA₁ is formed outside the dummy region DA₁ to connect a terminal portion of the address electrode 9 to a driving circuit. The dummy region DA₁ refers to the area outside of the display region D including the dummy barrier ribs 18. The dummy region DA₁ also refers to a region including a terminal connecting region (TCA₁) that connects the address electrode 9 to the interconnection region ICA₁. The dummy region DA₁ is formed at the outside of the display region D at a predetermined distance (gap size) C from the sealing line 23.

Since the dummy barrier ribs 18 are formed so as to approach the sealing line 23, a very small gap size C is formed between the front ends of the dummy barrier ribs 18 and the sealing line 23, as shown in FIG. 5. The gap size C defines a distance at which the front ends of the dummy barrier ribs 18 approach the sealing line 23 at the maximum error range for avoiding contact with the sealing line 23. As the dummy barrier ribs 18 minimize the distance C, the empty space between the rear panel 100 and the front panel 200 in the non-display region ND becomes even smaller, causing the panels 100 and 200 of the substrates 1 and 2 to come into contact with each other over a larger area. As a result, when the PDP is driven, it is possible to further reduce the noise and vibration generated outside the display region D.

The non-display region ND includes a dummy region DA₂ formed in a vertical direction (see FIG. 1) and terminal connecting regions (TCA₂) formed in a horizontal direction (see FIG. 1) in the dummy region DA₂. An interconnection region ICA₂ is formed outside the dummy region DA₂ to connect terminal portions of the display electrodes 3 and 5 to driving circuits. The dummy region DA₂ refers to the area outside of the display region D that includes the barrier rib 17. The dummy region DA₁ also refers to a region including a terminal connecting region (TCA₂) to connect the display electrodes 3 and 5 to the interconnection region ICA₂. The dummy region DA₁ of the rear panel 100 partially corresponds to the terminal connecting regions (TCA₂) and the dummy region DA₂ of the front panel 200.

In the embodiments of the present invention, the non-display region is formed outside the display region, the dummy region having the dummy barrier ribs is maximally formed in the non-display region, the rear substrate and the front substrate adhere closely to each other in the non-display region outside the display region and the space between both substrates is minimized. As a result, it is possible to eliminate the noise source formed outside the display region.

Although the present invention has been described with reference to a few exemplary embodiments and the accompanying drawings, the present invention is not limited thereto, and it would be appreciated by those skilled in the art that changes may be made without departing from the principles and spirit of the invention, the scope of which is defined in the claims and their equivalents.

What is claimed is:

1. A plasma display panel comprising:
a pair of substrates that are bonded along a sealing line formed adjacent to an edge of an overlapping region where the pair of substrates overlap while opposing each other;
a display region that includes discharge cells divided by barrier ribs formed within the overlapping region between the pair of substrates, phosphor layers formed in the discharge cells and electrodes provided to correspond to each of the discharge cells to display an image; and
a non-display region formed outside the display region,
wherein the non-display region includes a dummy region having dummy barrier ribs and a margin region formed between the dummy region and the sealing line,
wherein the margin region is smaller than the dummy region.

2. The plasma display panel of claim 1, wherein the margin region has a width C that is greater than a maximum error range in forming the sealing line and is equal to or smaller than 140% of the maximum error range.

3. The plasma display panel of claim 1, wherein the width C is 1.5 mm<C≦2 mm.

4. The plasma display panel of claim 1, wherein the dummy barrier rib has the same pattern as the barrier rib.

5. The plasma display panel of claim 4, wherein the sealing line is formed of glass frit.

6. A plasma display panel comprising:
a pair of substrates that are bonded along a sealing line formed adjacent to an edge of a region where the pair of substrates overlap while opposing each other;
a display region that includes discharge cells divided by barrier ribs formed within an overlapping region between the pair of substrates, phosphor layers formed in the respective discharge cells and electrodes provided to correspond to the respective discharge cells so as to display an image; and
a non-display region formed outside the display region,
wherein the non-display region includes dummy barrier ribs each having one end connected to the display region,
wherein each other end of the dummy barrier ribs and the sealing line define a gap, and
wherein the gap is greater than a maximum error range in forming the sealing line and is equal to or smaller than 140% of the maximum error range.

7. The plasma display panel of claim 6, wherein the non-display region includes a dummy region, which is formed outside the display region and has dummy barrier ribs.

8. The plasma display panel of claim 7, wherein the dummy barrier ribs have a same pattern as the barrier ribs.

9. The plasma display panel of claim 7, wherein the non-display region has a margin region having a width C corresponding to the gap formed between the dummy barrier rib and the sealing line.

10. The plasma display panel of claim 9, wherein the width C is 1.5 mm<C≦2 mm.
